(19) United States
(12) Patent Application Publication
(10) Pub. No.: US 2024/0329514 A1
(43) Pub. Date: Oct. 3, 2024

(54) PROJECTOR

(71) Applicant: SEIKO EPSON CORPORATION, Tokyo (JP)

(72) Inventor: Takuo YONEYAMA, Azumino-shi (JP)

(21) Appl. No.: 18/621,249

(22) Filed: Mar. 29, 2024

(30) Foreign Application Priority Data
Mar. 31, 2023 (JP) 2023-058623

(51) Int. Cl. G03B 33/12; G03B 21/14; G03B 21/20

(52) U.S. Cl. CPC G03B 33/12; G03B 21/142; G03B 21/2013; G03B 21/2033

(57) ABSTRACT

A projector includes a light separator configured to separate light emitted from a first light source device into first light with a first wavelength and second light with a second wavelength, a light combiner configured to combine light emitted from a first light modulator and light emitted from a second light modulator, a second light source device configured to emit invisible light, and an optical part configured to combine the first light emitted from the light separator and the invisible light emitted from the second light source device with each other. The invisible light includes first polarized light with a first polarization direction and second polarized light with a second polarization direction. The first light and the invisible light which are emitted from the optical part enter the first light modulator. A projection optical system projects light including the first light, the second light, and the invisible light.

The present application is based on, and claims priority from JP Application Serial Number 2023-058623, filed Mar. 31, 2023, the disclosure of which is hereby incorporated by reference herein in its entirety.

### BACKGROUND

### 1. Technical Field

The present disclosure relates to a projector.

### 2. Related Art

In order to perform control of a visible image as a display object, an image display device such as a projector superimposes the visible image and an invisible image such as an infrared image on a screen, and performs the control based on information which can be obtained from the invisible image in some cases. For example, in JP-A-2008-176195, there is disclosed a projector which separates infrared light from the light emitted from a light source to superimpose the infrared light on a projection image via a dedicated light modulation element.

In the device disclosed in JP-A-2008-176195 described above, there is a light modulator for the infrared light as the invisible light in addition to the light modulators for respective colored light beams of red light, green light, and blue light as visible light. Therefore, it is unachievable to directly trace a displacement and a shift of the projection image due to a factor on a light path of each of the colored light beams as the visible light. As a result, there has been a problem that the displacement of the projection image formed of actual visible light and the displacement thus detected fail to coincide with each other, and it is difficult to accurately perform an adjustment of the projection image based on the displacement.

### SUMMARY

In view of the problems described above, a projector according to an aspect of the present disclosure includes a first light source device configured to emit light including first light with a first wavelength and second light with a second wavelength different from the first wavelength, a light separator configured to separate the light emitted from the first light source device into the first light and the second light, a first light modulator configured to modulate the first light, a second light modulator configured to modulate the second light, a light combiner configured to combine light emitted from the first light modulator and light emitted from the second light modulator with each other, a projection optical system configured to project light emitted from the light combiner, a second light source device configured to emit invisible light, and an optical part configured to combine the first light emitted from the light separator and the invisible light emitted from the second light source device with each other. The invisible light emitted from the second light source device includes first polarized light with a first polarization direction and second polarized light with a second polarization direction different from the t first polarization direction. The first light and the invisible light which are emitted from the optical part enter the first light modulator. The projection optical system projects light including the first light, the second light, and the invisible light.

### BRIEF DESCRIPTION OF THE DRAWINGS

FIG. 1 is a schematic diagram of a projector

according to an embodiment of the present disclosure.

FIG. 2 is a plan view of a light transmissive member provided to the projector shown in FIG. 1.

FIG. 3 is a schematic diagram of a first modified example of a light source device of the projector shown in FIG. 1.

FIG. 4 is a schematic diagram of a light emitter of the light source device shown in FIG. 3.

FIG. 5 is a diagram of a polarization state of light emitted from the light emitter shown in FIG. 4 with a Poincare sphere.

### DESCRIPTION OF EMBODIMENTS

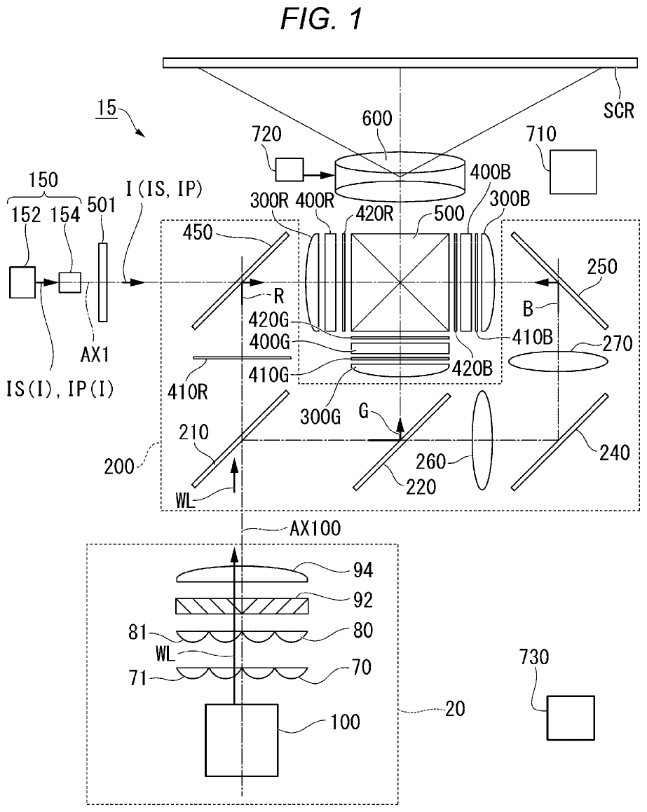

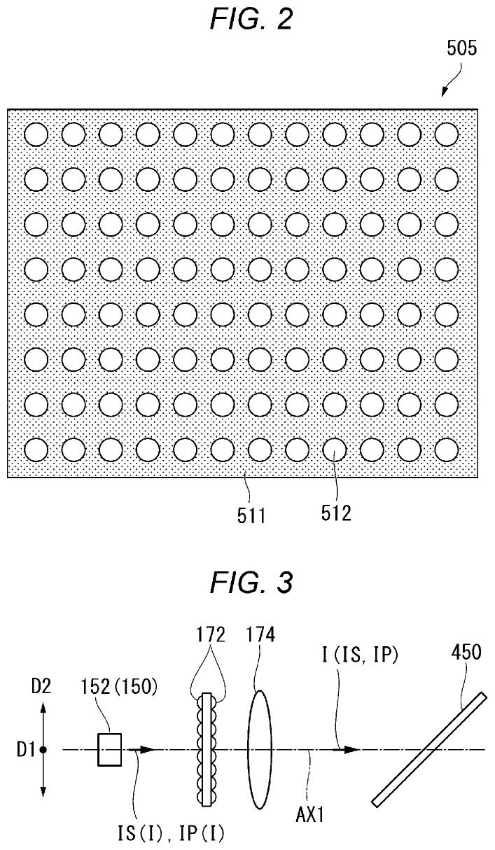

An embodiment of the present disclosure will hereinafter be described using FIG. 1 and FIG. 2.

FIG. 1 is a schematic diagram showing a configuration of a projector 15 according to the embodiment. The projector 15 is an image display device provided with liquid crystal panels as light modulators. In the drawings described below, in order to make elements eye-friendly, the scale ratio of the size is made different by the elements in some cases.

### Projector

As shown in FIG. 1, the projector 15 is provided with an illumination device 20, a light source device 150, a color separation optical system 200, field lenses 300R, 300G, and 300B, incident-side polarization plates 410R, 410G, and 410B, light modulators 400R, 400G, and 400B, exit-side polarization plates 420R, 420G, and 420B, a cross dichroic prism 500, a projection optical system 600, an imager 710, a movement mechanism 720, and a controller 730. The illumination device 20 emits white light WL obtained by combining red light R, green light G, and blue light B as visible light with each other.

The illumination device 20 is provided with a light source device 100, a first lens array 70, a second lens array 80, a polarization conversion element 92, and a superimposing lens 94. The light source device 100 emits the white light WL. The configuration of the light source device 100 will be described later.

The white light WL emitted from the light source device 100 is collimated, and then enters the first lens array 70. The first lens array 70 has a plurality of small lenses 71 for dividing the white light WL emitted from the light source device 100 into a plurality of partial light beams. The plurality of small lenses 71 are arranged in a matrix in a plane perpendicular to an optical axis AX100 of the light source device 100.

The second lens array 80 has a plurality of small lenses 81 corresponding respectively to the plurality of small lenses 71 of the first lens array 70. The plurality of small lenses 81 are arranged in a matrix in a plane perpendicular to the optical axis AX100. The second lens array 80 forms an image of each of the small lenses 71 of the first lens array 70 in the vicinity of each of the image forming areas of the light modulators 400R, 400G, and 400B in cooperation with the superimposing lens 94.

The polarization conversion element 92 has a polarization separation layer, a reflecting layer, and a wave plate not shown. The polarization conversion element 92 converts the partial light beams emitted from the second lens array 80 into linearly-polarized light. The polarization conversion element 92 is formed to have a plate shape as a whole. A plate surface of the polarization conversion element 92 is disposed in parallel to a plane perpendicular to the optical axis AX100. The polarization separation layer of the polarization conversion element 92 transmits one of the linear polarization components out of the polarization components included in the partial light beams emitted from the second lens array 80, and reflects the other of the linear polarization components in a direction perpendicular to the optical axis AX100. The reflecting layer of the polarization conversion element 92 reflects the other linear polarization component reflected by the polarization separation layer in a direction parallel to the optical axis AX100. The wave plate of the polarization conversion element 92 converts the other linear polarization component reflected by the reflecting layer into the one linear polarization component.

The superimposing lens 94 collects the partial light beams from the polarization conversion element 92 to thereby superimpose the partial light beams in the vicinity of each of the image forming areas of the light modulators 400R, 400G, and 400B. The first lens array 70, the second lens array 80, and the superimposing lens 94 constitute an integrator optical system. The integrator optical system homogenizes an in-plane light intensity distribution of the white light WL emitted from the illumination device 20 in each of the image forming areas of the light modulators 400R, 400G, and 400B.

The color separation optical system 200 is provided with dichroic mirrors 210, 220, and 450, reflecting mirrors 240, 250, and relay lenses 260, 270. The color separation optical system 200 separates the white light WL emitted from the illumination device 20 into the red light R, the green light G, and the blue light B as visible light, and then guides the red light R, the green light G, and the blue light B to the light modulators 400R, 400G, and 400B, respectively. Further, in the color separation optical system 200, there is introduced infrared light I.

The dichroic mirror 210 transmits the red light R and reflects the green light G and the blue light B out of the white light WL which enters the dichroic mirror 210. The dichroic mirror 220 reflects the green light G and transmits the blue light B out of the green light G and the blue light B which enter the dichroic mirror 220. The dichroic mirror 450 reflects substantially all of the red light R which enters the dichroic mirror 450. The reflecting mirrors 240, 250 each reflect substantially all of the blue light B which enters the reflecting mirrors 240, 250.

The light source device 150 emits invisible light such as the infrared light I. The invisible light includes infrared S-polarized light IS which is first polarized light with a first polarization direction out of the infrared light I, and infrared P-polarized light IP which is second polarized light with a second polarization direction different from the first polarization direction. The light source device 150 is provided with a light emitter 152 and a birefringent part 154. The light emitter 152 includes, for example, an infrared LED for emitting the infrared light I as unpolarized light, or an infrared laser low in polarization degree, and emits the infrared light I as the unpolarized light. The birefringent part 154 is disposed on a light path of the infrared light I emitted from the light emitter 152. The infrared light I emitted from the light emitter 152 enters the birefringent part 154. The birefringent part 154 emits the infrared light I including the infrared S-polarized light IS which is the first polarized light with the first polarization direction and the infrared P-polarized light IP which is the second polarized light with the second polarization direction. The infrared light I emitted from the light source device 150 is transmitted through the dichroic mirror 450, and then proceeds on the light path overlapping the red light R reflected by the dichroic mirror 450 in a plan view, in the same direction as that of the red light R thus reflected.

The field lens 300R is disposed between the color separation optical system 200 and the light modulator 400R on the light path of the red light R, the field lens 300G is disposed between the color separation optical system 200 and the light modulator 400G on the light path of the green light G, and the field lens 300B is disposed between the color separation optical system 200 and the light modulator 400B on the light path of the blue light B. The red light R having been reflected by the dichroic mirror 450 is transmitted through the field lens 300R, and then enters the image forming area of the light modulator 400R. The green light G reflected by the dichroic mirror 220 is transmitted through the field lens 300G, and then enters the image forming area of the light modulator 400G. The blue light B reflected by the reflecting mirror 250 is transmitted through the field lens 300B, and then enters the image forming area of the light modulator 400B.

The light modulator 400R is formed of a liquid crystal panel for modulating the red light R entering the light modulator 400R in accordance with image information to form an image, the light modulator 400G is formed of a liquid crystal panel for modulating the green light G entering the light modulator 400G in accordance with the image information to form an image, and the light modulator 400B is formed of a liquid crystal panel for modulating the blue light B entering the light modulator 400B in accordance with the image information to form an image. An operation mode of the liquid crystal panel can be any of a TN mode, a VA mode, a transverse electric field mode, and so on, and is not limited to a specific mode.

The incident-side polarization plate 410R is disposed on the light path of the red light R between the dichroic mirror 210 and the dichroic mirror 450. The incident-side polarization plate 410G is disposed at a light incidence surface side of the light modulator 400G, and the incident-side polarization plate 410B is disposed at a light incidence surface side of the light modulator 400B. The exit-side polarization plate 420R is disposed at a light exit surface side of the light modulator 400R, the exit-side polarization plate 420G is disposed at a light exit surface side of the light modulator 400G, and the exit-side polarization plate 420B is disposed at a light exit surface side of the light modulator 400B.

The cross dichroic prism 500 combines the image light emitted from the light modulator 400R, the image light emitted from the light modulator 400G, and the image light emitted from the light modulator 400B with each other to form a color image. As shown in FIG. 1, the cross dichroic prism 500 is constituted with four rectangular prisms arranged so that the respective vertex angles overlap each other at a common central position in a side view, and is formed to have a substantially cubic shape as a whole. In the cross dichroic prism 500, on interfacial surfaces on which the rectangular prisms are bonded to each other, there are formed dielectric multilayer films not shown. The interfacial surfaces described above are formed to have a substantially X shape in the side view.

The color image emitted from the cross dichroic prism 500 is in an enlarged manner by the projection optical system 600 to form an image on a screen SCR.

The imager 710 takes the projection image including the infrared light I and the red light R projected by the projection optical system 600. The imager 710 is, for example, an imaging camera, and can be disposed at a place where the imager 710 does not block the light emitted from the projection optical system 600 in the projector 15, or can be installed at an arbitrary place.

The movement mechanism 720 receives an electric signal from the controller 730, then moves the projection optical system 600 to change the position of the projection image.

It is possible for the controller 730 to control the movement mechanism 720 in accordance with the imaging result taken by the imager 710. It is possible for the controller 730 to change the area where the image is formed in the image forming area of the light modulator 400R corresponding to the red light R in accordance with the imaging result taken by the imager 710. The controller 730 is formed of, for example, a computer incorporating processing of drive devices for driving the imager 710, the movement mechanism 720, the light source device 150, and the light modulators 400R, 400G, and 400B as a program, or an integrated circuit. In other words, the controller 730 is, for example, a processor. The controller 730 is connected to each of the imager 710, the movement mechanism 720, and the light modulators 400R, 400G, and 400B with wire not shown, or wirelessly.

In the projector 15, it is preferable for a diffractor 501 to be disposed at the light exit side of the light source device 150, and to diffract the infrared light I as an example of the invisible light. The infrared light I as the invisible light projected by the projection optical system 600 includes a predetermined pattern. The predetermined pattern is determined in accordance with a surface pattern of the diffractor 501.

The projector 15 can further be provided with a light transmissive member 505 illustrated in FIG. 2 which is disposed at one of the light incident side and the light exit side of the light modulator 400R. The light transmissive member 505 has a shield part 511 for reflecting the invisible light and transmitting the red light R as an example of the first light, and a transmission part 512 for transmitting both of the infrared light I as the invisible light and the red light R as the first light. The infrared light I as the invisible light projected by the projection optical system 600 includes the predetermined pattern. The predetermined pattern is, for example, a dot-like pattern.

The projector 15 according to the present embodiment described hereinabove is provided with the light source device 100 as a first light source device, the dichroic mirror 210 as a light separator, the light modulator 400R as a first light modulator, the light modulators 400G, 400B as a second light modulator, the cross dichroic prism 500 as a light combiner, the projection optical system 600, the light source device 150 as a second light source device, and the dichroic mirror 450 as an optical part.

The light source device 100 emits light including the first light with a first wavelength and second light with a second wavelength different from the first wavelength, namely the white light WL. The red light R corresponds to the first light with the first wavelength. The green light G and the blue light B each correspond to the second light with the second wavelength different from the red light R. The dichroic mirror 210 separates the white light WL which is emitted from the light source device 100 into the red light R, the green light G, and the blue light B. The light modulator 400R modulates the red light R. The light modulator 400G modulates the green light G. The light modulator 400B modulates the blue light B. The cross dichroic prism 500 combines the light emitted from the light modulator 400R, the light emitted from the light modulator 400G, and the light emitted from the light modulator 400B with each other. The projection optical system 600 projects the light emitted from the cross dichroic prism 500. The light source device 150 emits the invisible light such as the infrared light I. The dichroic mirror 450 overlaps the red light R emitted from the dichroic mirror 210 and the infrared light I emitted from the light source device 150 on the same light path to thereby combine the red light R and the infrared light I with each other. The infrared light I emitted from the light source device 150 is the invisible light including the infrared S-polarized light IS which is the first polarized light with the first polarization direction, and the infrared P-polarized light IP which is the second polarized light with the second polarization direction different from the first polarization direction. The red light R and the infrared light I emitted from the dichroic mirror 450 enter the light modulator 400R. The projection optical system 600 projects light including the red light R, the green light G, the blue light B, and the infrared light I.

The projector 15 according to the present embodiment is provided with the light source device 150 for emitting the infrared light I as the invisible light separately from the light source device 100 for forming the projection image. The light source device 150 is an infrared laser for emitting, for example, the infrared S-polarized light IS or the infrared P-polarized light IP. In the projector 15 according to the present embodiment, the light path of the infrared light I emitted from the light source device 150 is overlapped with one of the light paths of the colored light beams in the color separation optical system 200. In the projector 15 according to the present embodiment, for example, the red light R and the infrared light I the light paths of which are overlapped with each other pass through the common light modulator 400R, and the other colored light beams than these colored light beams such as the green light G and the blue light B respectively pass through the light modulators 400G, 400B, and the red light R, the infrared light I, the green light G, and the blue light B are combined with each other to be emitted as the projection light. Therefore, in the projector 15 according to the present embodiment, it is possible to directly trace the displacement and the shift of the projection image due to a factor on a light path of any one of the colored light beams as visible light. According to the projector 15 related to the present embodiment, the displacement of the projection image formed of the actual visible light and the displacement thus detected coincide with each other, and it is possible to accurately perform an adjustment of the projection image based on the displacement.

The projector 15 according to the present embodiment is further provided with the incident-side polarization plate 410R as a first polarizer, and the exit-side polarization plate 420R as a second polarizer. The incident-side polarization plate 410R is disposed between the dichroic mirror 210 as a light separator and the light modulator 400R as a first light modulator, and is specifically disposed between the dichroic mirror 210 and the dichroic mirror 450. The red light R emitted from the dichroic mirror 210 enters the incident-side polarization plate 410R. The exit-side polarization plate 420R is disposed between the light modulator 400R as the first light modulator and the cross dichroic prism 500 as the light combiner. The red light R as the first light and the infrared light I as the invisible light emitted from the light modulator 400R enter the exit-side polarization plate 420R. The incident-side polarization plate 410R emits red S-polarized light as the first light with the first polarization direction. The light modulator 400R emits light including the infrared P-polarized light IP as second polarized light out of the infrared light I as the invisible light, and at least one of the red S-polarized light as the first light with the first polarization direction and red P-polarized light as the first light with the second polarization direction different from the first polarization direction. The exit-side polarization plate 420R emits the infrared P-polarized light as the second polarized light and the red P-polarized light. According to the projector 15 related to the present embodiment, the polarization state of the red light R as an example of the first light and the infrared light I is clearly switched, and it is possible to suppress the loss of the red light R and the infrared light I, and at the same time, it is possible to make the projection image clear.

In the projector 15 according to the present embodiment, the light source device 150 as the second light source device has the light emitter 152 and the birefringent part 154. The light emitter 152 emits the infrared light I as the unpolarized invisible light. The infrared light I as the invisible light enters the birefringent part 154. The birefringent part 154 emits the infrared S-polarized light IS as an example of the first polarized light and the infrared P-polarized light IP as an example of the second polarized light. According to the projector 15 related to the present embodiment, it is possible to use the infrared LED or an infrared laser as the light emitter 152 to simply configure the light source device 150 to thereby achieve a reduction in size.

In the projector 15 according to the present embodiment, the dichroic mirror 450 as the optical part reflects the red light R as the first light, and at the same time, transmits the infrared light I as the invisible light. The light source device 150 is disposed at an opposite side to the light modulator 400R as the first light modulator with respect to the dichroic mirror 450.

In the projector 15 according to the present embodiment, the light path of the infrared light I emitted from the light source device 150 is overlapped with the light path of the red light R as one of the light paths of the colored light beams in the color separation optical system 200. According to the projector 15 related to the present embodiment, it is possible to directly trace the displacement and the shift of the projection image due to the factor on the light path of the red light R as the first light.

In the projector 15 according to the present embodiment, the first light is the red light R, and the invisible light is the infrared light I. The dichroic mirror 450 as the optical part combines the red light R and the infrared light I with each other to emit the result. The red light R has a wavelength the closest to that of the infrared light I out of the colored light beams of the three primary colors for forming the projection image. According to the projector 15 related to the present embodiment, it is possible to make the polarization state of the red light R and the infrared light I act in good condition.

In the projector 15 according to the present embodiment, the first light is the blue light B, and the invisible light is ultraviolet light. The optical part combines the blue light B and the ultraviolet light with each other to emit the result. The blue light B has a wavelength the closest to that of the ultraviolet light out of the colored light beams of the three primary colors for forming the projection image. According to the projector 15 related to the present embodiment, it is possible to make the polarization state of the blue light B and the ultraviolet light act in good condition.

The projector 15 according to the present embodiment can further be provided with the diffractor 501 which is disposed at the light exit side of the light source device 150, and diffracts the infrared light I as an example of the invisible light. The infrared light I as the invisible light projected by the projection optical system 600 includes the predetermined pattern.

The projector 15 according to the present embodiment can further be provided with the light transmissive member 505 which is disposed at one of the light incident side and the light exit side of the light modulator 400R. The light transmissive member 505 has the shield part 511 for reflecting the invisible light and transmitting the red light R as an example of the first light, and the transmission part 512 for transmitting both of the infrared light I as the invisible light and the red light R as the first light. The infrared light I as the invisible light projected by the projection optical system 600 includes the predetermined pattern.

According to the projector 15 related to the present embodiment, the invisible light, namely the infrared light I, having the predetermined pattern is projected on the projection surface such as the screen SCR, and by detecting the position information and so on of the predetermined pattern, it is possible to accurately detect the displacement of the projection image constituted by the actual visible light.

The projector 15 according to the present embodiment is further provided with the imager 710, the movement mechanism 720, and the controller 730. The imager 710 takes the projection image including the infrared light I as the invisible light and the red light R as the first light projected by the projection optical system 600. The movement mechanism 720 moves the projection optical system 600 to change the position of the projection image. The controller 730 controls the movement mechanism 720 in accordance with the imaging result taken by the imager 710.

According to the projector 15 related to the present embodiment, it is possible to accurately move the projection optical system 600 to an optimum position using the controller 730.

The projector 15 according to the present embodiment is further provided with the imager 710, and the controller 730. The imager 710 takes the projection image including the infrared light I as the invisible light and the red light R as an example of the first light projected by the projection optical system 600. The controller 730 changes the area where the image is formed in the image forming area of the light modulator 400R in accordance with the imaging result taken by the imager 710.

### Modified Example of Second Light Source Device

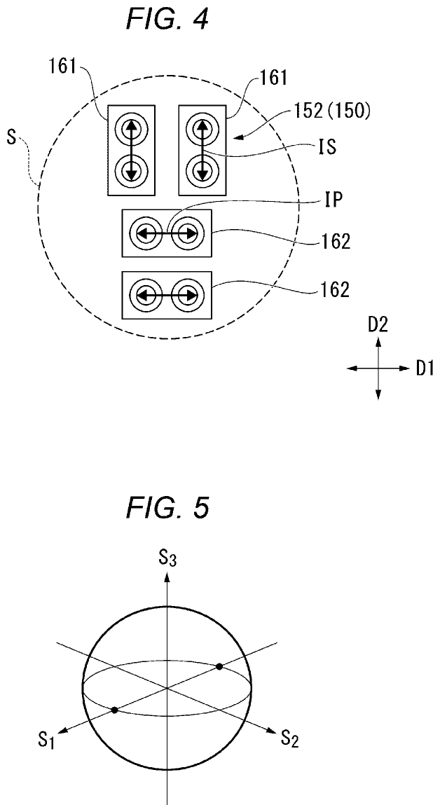

FIG. 3 is a schematic diagram of a first modified example of the light source device 150 as the second light source device. FIG. 4 is a schematic diagram when viewing the light emitter 152 of the light source device 150 along an optical axis AXI. FIG. 5 is a diagram showing a state of the polarization of the infrared light I emitted from the light emitter 152 using a Poincare sphere. As shown in FIG. 4, the light emitter 152 is provided with, for example, two first laser sources 161, 161, and two second laser sources 162, 162. The two first laser sources 161, 161 are disposed along a direction DI perpendicular to the optical axis AXI of the light source device 150. Each of the first laser sources 161 emits the infrared S-polarized light IS. The two second laser sources 162, 162 are disposed along a direction D2 perpendicular to the optical axis AXI and the direction D1. Each of the second laser sources 162 emits the infrared P-polarized light IP. In FIG. 4, there are indicated vibration directions of the infrared S-polarized light IS and the infrared P-polarized light IP with arrows. The two first laser sources 161, 161 and the two second laser sources 162, 162 are relatively disposed so as to correspond to the light emitting area S of the light emitter 152. As shown in FIG. 5, the plots on the Poincare sphere of the infrared light I emitted from the light emitter 152 and the light source device 150 in the first modified example are symmetric about the center. In the first modified example, two lens array surfaces 172, 172, and a superimposing lens 174 are arranged in sequence on the light path of the infrared light I between the light emitter 152 and the dichroic mirror 450. The two lens array surfaces 172, 172 are a surface at the incident side and a surface at the exit side of a double-sided multi lens, respectively.

As described above, in the modified example of the projector 15 according to the present embodiment, the light source device 150 as the second light source device can be provided with the first laser sources 161 and the second laser sources 162. The first laser sources 161 are arranged along the direction D1 as a first direction perpendicular to the optical axis AXI of the light source device 150, and emit the infrared S-polarized light IS as the first polarized light with the first polarization direction. The second laser sources 162 are arranged along the direction D2 perpendicular to the optical axis AXI, and emit the infrared P-polarized light IP as the second polarized light with the second polarization direction. According to the modified example of the projector 15 related to the present embodiment, it is possible to increase the light intensity of the infrared light I emitted from the light source device 150 to make the image of the infrared light I to be projected clear.

As another modified example, it is possible for the light source device 150 as the second light source device to be provided with the first laser sources 161, the second laser sources 162, a third laser source 163, and a fourth laser source 164. The first laser sources 161 are arranged along the direction DI as the first direction perpendicular to the optical axis AXI of the light source device 150, and emit the infrared S-polarized light IS as the first polarized light with the first polarization direction. The second laser sources 162 are arranged along the direction D2 perpendicular to the optical axis AXI, and emit the infrared P-polarized light IP as the second polarized light with the second polarization direction. The third laser source 163 is disposed along the direction D1, and is disposed at a position symmetric to the first laser sources 161 about the optical axis AXI, and emits the infrared S-polarized light IS. The fourth laser source 164 is disposed along the direction D2, and is disposed at a position symmetric to the second laser sources 162 about the optical axis AXI, and emits the infrared P-polarized light IP. According to the modified example of the projector 15 related to the present embodiment, it is possible to increase the light intensity of the infrared light I emitted from the light source device 150 to make the image of the infrared light I to be projected clear.

As still another modified example, the light source device 150 as the second light source device can be provided with the first laser sources 161 and the second laser sources 162. The first laser sources 161 emit the infrared light I which is the first polarized light as first circularly-polarized light with a first rotational direction. The second laser sources 162 emit the infrared light I which is the second polarized light as the second circularly-polarized light a with second rotational direction opposite to the first rotational direction.

The preferred embodiments of the present disclosure are hereinabove described in detail, but the present disclosure is not limited to such specific embodiments, and there can be adopted a variety of deformations and modifications within the scope or the spirit of the present disclosure set forth in the appended claims. Further, the elements of the plurality of embodiments can arbitrarily be combined with each other.

For example, the first light can be the blue light B, and the invisible light can be the ultraviolet light. In that case, the optical part combines the blue light B and the ultraviolet light with each other to emit the result.

### Conclusion of Present Disclosure

Hereinafter, the conclusion of the present disclosure will supplementarily be noted.

### Supplementary Note 1

A projector including a first light source device configured to emit light including first light with a first wavelength and second light with a second wavelength different from the first wavelength, a light separator configured to separate the light emitted from the first light source device into the first light and the second light, a first light modulator configured to modulate the first light, a second light modulator configured to modulate the second light, a light combiner configured to combine light emitted from the first light modulator and light emitted from the second light modulator with each other, a projection optical system configured to project light emitted from the light combiner, a second light source device configured to emit invisible light, and an optical part configured to combine the first light emitted from the light separator and the invisible light emitted from the second light source device with each other, wherein the invisible light emitted from the second light source device includes first polarized light with a first polarization direction and second polarized light with a second polarization direction different from the first polarization direction, the first light and the invisible light which are emitted from the optical part enter the first light modulator, and the projection optical system projects light including the first light, the second light, and the invisible light.

Due to the configuration in Supplementary Note 1, the displacement of the projection image formed of the actual visible light and the displacement thus detected coincide with each other, and it is possible to accurately perform an adjustment of the projection image based on the displacement.

### Supplementary Note 2

The projector described in Supplementary Note 1 further including a first polarizer which is disposed between the light separator and the first light modulator, and which the first light emitted from the light separator enters, and a second polarizer which is disposed between the first light modulator and the light combiner, and which the first light and the invisible light which are emitted from the first light modulator enter, wherein the first polarizer emits the first light with the first polarization direction, the first light modulator emits light includes the second polarized light out of the invisible light and at least one of the first light with the first polarization direction and the first light with the second polarization direction, and the second polarizer emits the second polarized light and the first light with the second polarization direction.

Due to the configuration in Supplementary Note 2, it is possible to suppress the loss of the first light and the invisible light, and at the same time, it is possible to make the projection image clear.

### Supplementary Note 3

The projector described in one of Supplementary Note 1 and Supplementary Note 2, wherein the second light source device includes a light emitter configured to emit the invisible light as unpolarized light, and a birefringent part which the invisible light enters, and which is configured to emit the first polarized light and the second polarized light.

Due to the configuration in Supplementary Note 3, it is possible to realize the second light source device which is simple, and which is provided with the light emitter and the birefringent part.

### Supplementary Note 4

The projector described in one of Supplementary Note 1 and Supplementary Note 2, wherein the second light source device includes a first laser source disposed along a first direction perpendicular to an optical axis of the second light source device, and configured to emit the first polarized light with the first polarization direction, and a second laser source disposed along a second direction perpendicular to both of the optical axis of the second light source device and the first direction, and configured to emit the second polarized light with the second polarization direction.

Due to the configuration in Supplementary Note 4, it is possible to increase the light intensity of the invisible light emitted from the second light source device to make the image of the invisible light to be projected clear.

### Supplementary Note 5

The projector described in Supplementary Note 1 and Supplementary Note 2, wherein the second light source device includes a first laser source disposed along a first direction perpendicular to an optical axis of the second light source device, and configured to emit the first polarized light with the first polarization direction, a second laser source disposed along a second direction perpendicular to both of the optical axis of the second light source device and the first direction, and configured to emit the second polarized light with the second polarization direction, a third laser source disposed along the first direction and disposed at a position symmetric to the first laser source about the optical axis of the second light source device, and configured to emit the first polarized light with the first polarization direction, and a fourth laser source disposed along the second direction and disposed at a position symmetric to the second laser source about the optical axis of the second light source device, and configured to emit the second polarized light with the second polarization direction.

Due to the configuration in Supplementary Note 5, it is possible to realize a desired illuminance distribution of the invisible light in the light emitter due to the arrangement of the laser source different from the configuration in Supplementary Note 4 to thereby increase the light intensity of the invisible light to be emitted from the second light source device, and thus, make the image of the invisible light to be projected clear.

### Supplementary Note 6

The projector described in one of Supplementary Note 1 and Supplementary Note 2, wherein the second light source device includes a first laser source configured to emit the first polarized light as first circularly-polarized light with a first rotational direction, and a second laser source configured to emit the second polarized light as second circularly-polarized light with a second rotational direction opposite to the first rotational direction.

Due to the configuration in Supplementary Note 6, it is possible to realize a desired illuminance distribution of the invisible light in the light emitter due to a polarization distribution from the laser source different from that of the configuration in Supplementary Note 4 and Supplementary Note 5 to thereby increase the light intensity of the invisible light to be emitted from the second light source device, and thus, make the image of the invisible light to be projected clear.

### Supplementary Note 7

The projector described in any one of Supplementary Note 1 through Supplementary Note 6, wherein the optical part is configured to reflect the first light and transmit the invisible light, and the second light source device is disposed at an opposite side to the first light modulator with respect to the optical part.

Due to Supplementary Note 7, it is possible to directly trace the displacement and the shift of the projection image due to the factor on the light path of the first light.

### Supplementary Note 8

The projector described in Supplementary Note 2, wherein the first light is red light, the invisible light is infrared light, and the optical part is configured to combine the red light and the infrared light with each other to emit the red light and the infrared light combined with each other.

Due to the configuration in Supplementary Note 8, it is possible to make the polarization state of the infrared light and the red light, which has a wavelength closer to that of the infrared light than those of the visible light beams of other colors, act in good condition.

### Supplementary Note 9

The projector described in Supplementary Note 2, wherein the first light is blue light, the invisible light is ultraviolet light, and the optical part is configured to combine the blue light and the ultraviolet light with each other to emit the blue light and the ultraviolet light combined with each other.

Due to the configuration in Supplementary Note 9, it is possible to make the polarization state of the ultraviolet light and the blue light, which has a wavelength closer to that of the ultraviolet light than those of the visible light beams of other colors, act in good condition.

### Supplementary Note 10

The projector described in any one of Supplementary Note 3 through Supplementary Note 6, wherein the second light source device further includes a diffractor disposed at a light exit side of the first laser source and the second laser source and configured to diffract the invisible light, and the invisible light projected by the projection optical system includes a predetermined pattern.

Due to the configuration in Supplementary Note 10, the invisible light having the predetermined pattern is projected, and by detecting the position information and so on of the predetermined pattern, possible to accurately detect the displacement of the projection image constituted by the actual visible light.

### Supplementary Note 11

The projector described in any one of Supplementary Note 1 through Supplementary Note 9, further including a light transmissive member disposed at one of a light incident side and a light exit side of the first light modulator, wherein the light transmissive member includes a shield part configured to reflect the invisible light and transmit the first light, and a transmission part configured to transmit both of the invisible light and the first light, and the invisible light projected by the projection optical system includes a predetermined pattern.

Due to the configuration in Supplementary Note 11, the invisible light having the predetermined pattern is projected, and the position information of the predetermined pattern and so on are detected, and therefore, it is possible to accurately detect the displacement of the projection image constituted by the actual visible light.

### Supplementary Note 12

The projector described in any one of Supplementary Note 1 through Supplementary Note 11, further including an imager configured to take a projection image including the invisible light and the first light which are projected by the projection optical system, a movement mechanism configured to move the projection optical system to change a position of the projection image, and a controller configured to control the movement mechanism in accordance with an imaging result taken by the imager.

Due to the configuration in Supplementary Note 12, it is possible to accurately move the projection optical system to an optimum position using the controller.

### Supplementary Note 13

The projector described in any one of Supplementary Note 1 through Supplementary Note 11, further including an imager configured to take a projection image including the invisible light and the first light which are projected by the projection optical system, and a controller configured to change an area where an image is formed in an image forming area of the first light modulator in accordance with an imaging result taken by the imager.

Due to the configuration in Supplementary Note 13, it is possible to accurately move the relative position of the image in the image forming area of the first light modulator to an optimum position using the controller.

What is claimed is:

1. A projector comprising:
a first light source device configured to emit light including first light with a first wavelength and second light with a second wavelength different from the first wavelength;
a light separator configured to separate the light emitted from the first light source device into the first light and the second light;
a first light modulator configured to modulate the first light;
a second light modulator configured to modulate the second light;
a light combiner configured to combine light emitted from the first light modulator and light emitted from the second light modulator with each other;
a projection optical system configured to project light emitted from the light combiner;
a second light source device configured to emit invisible light; and
an optical part configured to combine the first light emitted from the light separator and the invisible light emitted from the second light source device with each other, wherein
the invisible light emitted from the second light source device includes first polarized light with a first polarization direction and second polarized light with a second polarization direction different from the first polarization direction,
the first light and the invisible light which are emitted from the optical part enter the first light modulator, and
the projection optical system projects light including the first light, the second light, and the invisible light.

2. The projector according to claim 1, further comprising:
a first polarizer which is disposed between the light separator and the first light modulator, and which the first light emitted from the light separator enters; and
a second polarizer which is disposed between the first light modulator and the light combiner, and which the first light and the invisible light which are emitted from the first light modulator enter, wherein
the first polarizer emits the first light with the first polarization direction,
the first light modulator emits light including the second polarized light out of the invisible light and at least one of the first light with the first polarization direction and the first light with the second polarization direction, and
the second polarizer is configured to emit the second polarized light and the first light with the second polarization direction.

3. The projector according to claim 1, wherein
the second light source device includes
a light emitter configured to emit the invisible light as unpolarized light, and
a birefringent part which the invisible light enters, and which is configured to emit the first polarized light and the second polarized light.

4. The projector according to claim 1, wherein
the second light source device includes
a first laser source disposed along a first direction perpendicular to an optical axis of the second light source device, and configured to emit the first polarized light with the first polarization direction, and
a second laser source disposed along a second direction perpendicular to both of the optical axis of the second light source device and the first direction, and configured to emit the second polarized light with the second polarization direction.

5. The projector according to claim 1, wherein
the second light source device includes
a first laser source disposed along a first direction perpendicular to an optical axis of the second light source device, and configured to emit the first polarized light with the first polarization direction,
a second laser source disposed along a second direction perpendicular to both of the optical axis of the second light source device and the first direction, and configured to emit the second polarized light with the second polarization direction,
a third laser source disposed along the first direction and disposed at a position symmetric to the first laser source about the optical axis of the second light source device, and configured to emit the first polarized light with the first polarization direction, and
a fourth laser source disposed along the second direction and disposed at a position symmetric to the second laser source about the optical axis of the second light source device, and configured to emit the second polarized light with the second polarization direction.

6. The projector according to claim 1, wherein
the second light source device includes
a first laser source configured to emit the first polarized light as first circularly-polarized light with a first rotational direction, and
a second laser source configured to emit the second polarized light as second circularly-polarized light with a second rotational direction opposite to the first rotational direction.

7. The projector according to claim 1, wherein
the optical part is configured to reflect the first light and transmit the invisible light, and
the second light source device is disposed at an opposite side to the first light modulator with respect to the optical part.

8. The projector according to claim 2, wherein
the first light is red light,
the invisible light is infrared light, and
the optical part is configured to combine the red light and the infrared light with each other to emit the red light and the infrared light combined with each other.

9. The projector according to claim 2, wherein
the first light is blue light,
the invisible light is ultraviolet light, and
the optical part is configured to combine the blue light and the ultraviolet light with each other to emit the blue light and the ultraviolet light combined with each other.

10. The projector according to claim 4, wherein
the second light source device further includes a diffractor disposed at a light exit side of the first laser source and the second laser source and configured to diffract the invisible light, and
the invisible light projected by the projection optical system includes a predetermined pattern.

11. The projector according to claim 1, further comprising:
a light transmissive member disposed at one of a light incident side and a light exit side of the first light modulator, wherein
the light transmissive member includes a shield part configured to reflect the invisible light and transmit the first light, and a transmission part configured to transmit both of the invisible light and the first light, and
the invisible light projected by the projection optical system includes a predetermined pattern.

12. The projector according to claim 1, further comprising:
an imager configured to take a projection image including the invisible light and the first light which are projected by the projection optical system;
a movement mechanism configured to move the projection optical system to change a position of the projection image; and
a controller configured to control the movement mechanism in accordance with an imaging result taken by the imager.

13. The projector according to claim 1, further comprising:
an imager configured to take a projection image including the invisible light and the first light which are projected by the projection optical system; and
a controller configured to change an area where an image is formed in an image forming area of the first light modulator in accordance with an imaging result taken by the imager.
